(19) United States
(12) Patent Application Publication
(10) Pub. No.: US 2011/0145576 A1
(43) Pub. Date: Jun. 16, 2011

(54) Secure method of data transmission and encryption and decryption system allowing such transmission

(75) Inventor: Olivier BETTAN, Chilly Mazarin (FR)

(73) Assignee: THALES, NEUILLY SUR SEINE (FR)

(21) Appl. No.: 12/947,756

(22) Filed: Nov. 16, 2010

(30) Foreign Application Priority Data
Nov. 17, 2009 (FR) FR0905513

(51) Int. Cl. H04L 9/32

(52) U.S. Cl. 713/168

(57) ABSTRACT

A secure transmission is performed between at least one sender and one recipient, a method of which includes: a step of authenticating the sender to a trusted network to request the encryption of the data; a step of encryption of the data by the trusted network with the aid of an encryption key; a step of slicing the encryption key into arbitrary blocks; a step of storing the blocks in a memory space; a step of generation of an index including the sequence of addresses of the blocks in the memory space; a step of delivery, by the trusted network, of the encrypted data and of the index to the sender; the encrypted data and the index being transmitted to the recipient via a network, the recipient being able to authenticate himself with the trusted network to provide it with the encrypted data and the index, the trusted network reconstructing the encryption key on the basis of the index to decrypt the encrypted data and restoring the decrypted data to the recipient.

The present invention relates to a secure method of data transmission and to an encryption and decryption system allowing such transmission. It is applied notably for the transmission of secure data in an unprotected medium such as the Internet notably.

Secure data transmissions are generally done by enciphering these data. An encrypted document dispatched to a given recipient must be able to be deciphered by the latter. To this end, this recipient must possess the right decryption key.

When there are several authorized recipients, the so-called asymmetric mode of transmission requires that the sender use the public key of each recipient to encrypt. The sender must therefore be able to access these public keys and place trust in the system responsible for their delivery.

The other, so-called symmetric, mode of transmission avoids the use of a public key. One and the same key is used for encryption and decryption of a document. This symmetric mode requires the transmission of the encrypted document and of the key used to the recipients. If an attacker succeeds in simultaneously appropriating the encrypted document and the key used, he is then able to read the content of the document. Management of the key is therefore often problematic in so far as the key is liable to be intercepted. It generally compels hand-to-hand exchange and the maintaining of the secrecy of the key by the various participants, thus multiplying the possibilities of theft, copying or compromise.

Solutions are known for attempting to overcome these transmission security problems. Thus, quantum cryptography can make it possible to guarantee the integrity of a key exchanged by the participants, but it is expensive to implement. Should modification or interception be detected, the key is rejected and a new exchange is initialized. However, management of the keys poses several drawbacks, notably as regards the generation, storage and exchanging of the keys. In particular:
the recipients of messages must be known and identified at each dispatch;
the procedures and techniques used are generally unwieldy to implement and expensive;
the storage of a shared key is problematic and requires specific means;
multiplication of participants increases the risks of compromise;
an attack of the “Man-in-the-middle” type allows an intruder to substitute himself for a desired recipient, in this case if a data sender is duped he communicates all the elements constituting the secret, the key and the encrypted document.

An aim of the invention is notably to alleviate the aforementioned drawbacks. For this purpose, the subject of the invention is a method for securely transmitting data between at least one sender and one recipient, the method comprising at least:
a step of authenticating the sender to a trusted network so as to request the encryption of the said data;
a step of encryption of the said data by the trusted network with the aid of an encryption key;
a step of slicing the encryption key into arbitrary blocks:
a step of storing the blocks in a memory space;
a step of generation of an index comprising the sequence of addresses of the said blocks in the memory space;
a step of delivery, by the trusted network, of the encrypted data and of the index to the sender;
   the encrypted data and the said index being transmitted to the recipient via a network, the recipient being able to authenticate himself with the trusted network so as to provide it with the encrypted data and the said index, the trusted network reconstructing the encryption key on the basis of the index so as to decrypt the encrypted data and restoring the decrypted data to the recipient.

The encryption key is for example a single-use disposable encryption key.

Advantageously, the blocks of the encryption key are for example stored according to a deduplication mechanism.

The subject of the invention is also a system for encrypting and decrypting data, the said system allowing secure transmission of encrypted data between a sender user and a receiver user, the system comprising at least one trusted network and one infrastructure for authentication of the users on the said trusted network, the latter comprising at least:
means for encrypting and decrypting data by means of an encryption key;
means for storing the encryption key and generating an index upon each data encryption request, the said request being sent by a user, the index being created according to the following steps:
slicing of the encryption key into arbitrary blocks;
storing the blocks in a memory space;
generation of index comprising the sequence of addresses of the said blocks in the memory space, the encrypted data being delivered to the sender user with the index;
a step of delivery, by the trusted network, of the encrypted data and of the index to the sender;
means for reconstructing the encryption key on the basis of an index upon a decryption request sent by a user, the said request being accompanied by the said index and encrypted data, the encryption and decryption means performing the decryption of the data by means of the reconstructed encryption key.

The encryption and decryption means generate for example before each encryption a single-use disposable encryption key, this key being used for encryption.

The means for storing and for generating the index store for example the blocks of the encryption key according to a deduplication mechanism.

The means for storing, for generating the index and for reconstructing the encryption key may be integrated into one and the same server.

The means for encrypting and decrypting data are for example an encryption server:
receiving the encryption requests with the data to be encrypted;
providing the encryption keys to the index generation and storage means;
receiving the encrypted data and the reconstructed encryption key that are sent by the means for reconstructing the encryption key;
restoring the decrypted data.

The trusted network comprises for example an exchange server:
receiving the decryption requests with the encrypted data and the index;
transmitting the encrypted data and their index to the means for reconstructing the encryption key;
receiving the encrypted data and their index sent by the index generation and storage means;
delivering the encrypted data and their index.

A deduplication server comprises for example the means for storing, for generating the index and for reconstructing the encryption key.

Other characteristics and advantages of the invention will become apparent with the aid of the description which follows offered in relation to appended drawings which represent:

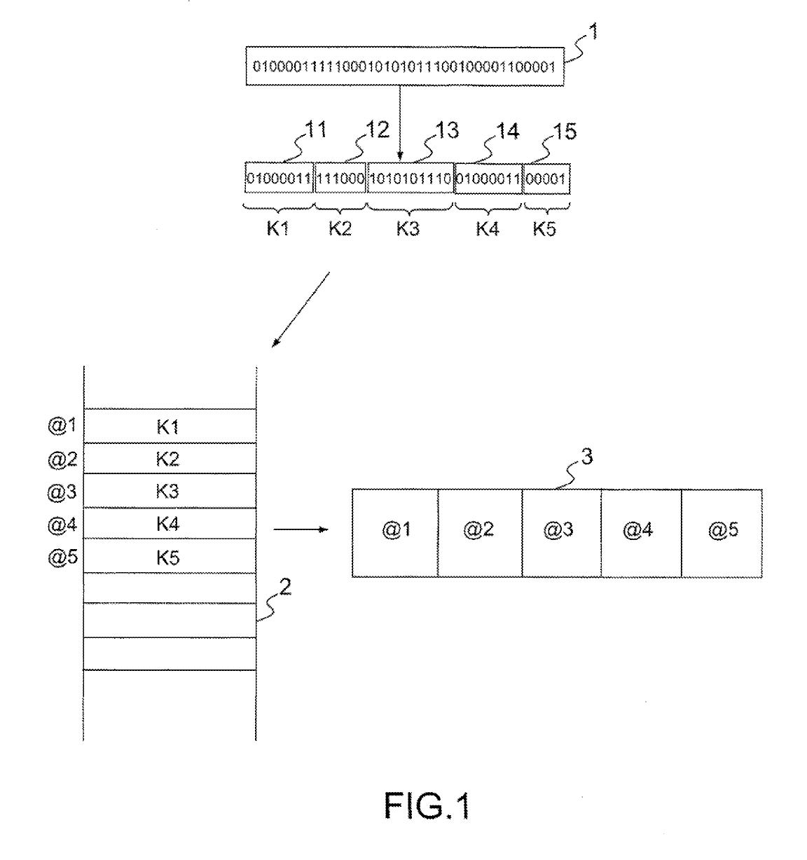

FIG. 1, an illustration of the principle of the invention;

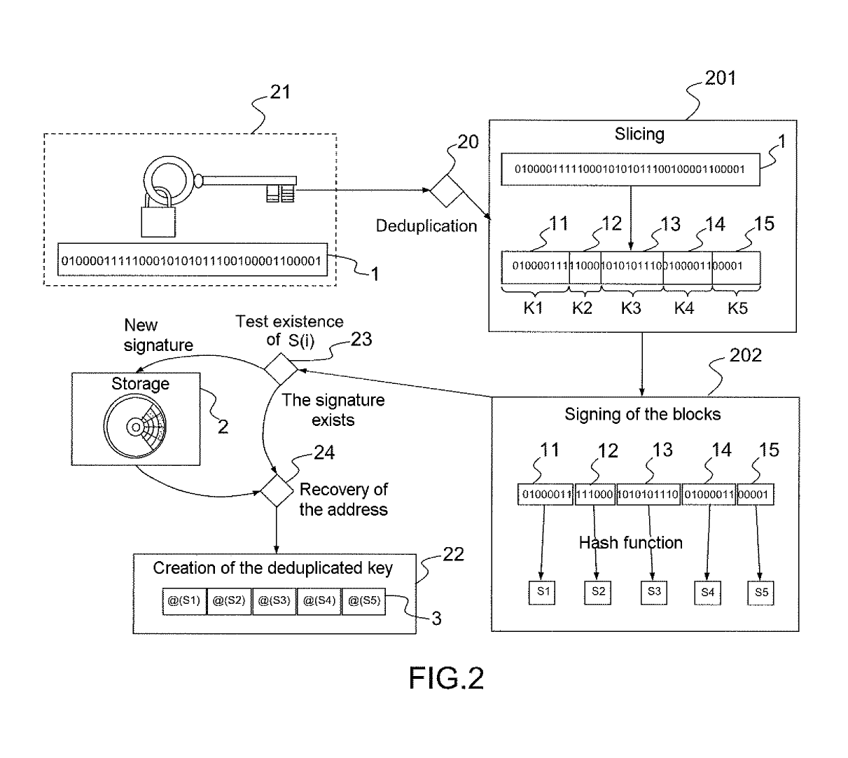

FIG. 2, an exemplary embodiment of an index used by the method according to the invention;

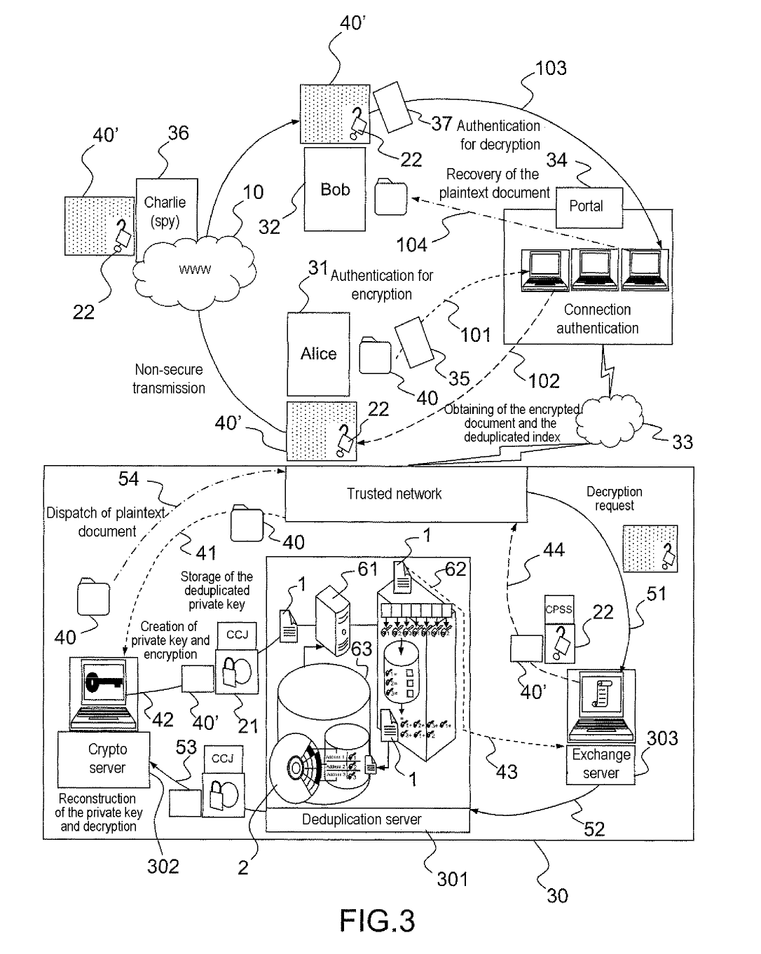

FIG. 3, an illustration of a possible embodiment of a system according to the invention with an exemplary use.

FIG. 1 illustrates the principle of implementation of the method according to the invention. According to the invention an index is stored and then distributed, arising from the slicing into segments of an encryption key 1, at the same time as the encrypted document. This key 1 corresponds to a word coded on a given number of bits. In the example of FIG. 1 the key is sliced into five blocks, or segments, 11, 12, 13, 14, 15 corresponding to five words K1, K2, K3, K4, K5. More generally, the key may be sliced into a multitude of blocks Ki, of variable size, whose juxtaposition subsequently allows reconstruction of the key itself.

The segments K1, K2, K3, K4, K5 are thereafter stored in an indexed memory space 2. Block K1 is stored at an address @1, block K2 is stored at an address @2, block K3 is stored at an address @3, block K4 is stored at an address @4 and block K5 is stored at an address @5. More generally, a block Ki is stored at an address @ i. The index 3, formed of the sequence of addresses @1, @2, @3, @4, @5, more generally @1, @2, . . . @ @N, makes it possible to reconstruct the initial encryption key by pointing at the successive addresses of the memory space. Advantageously, the encryption key is stored in pieces and must be reconstructed in order to be used. This reconstruction is possible only in possession of the index 3.

According to the invention the index 3, formed of the sequence of addresses @1, @2, @3, @4, @5, more generally @1, @2, . . . @ @N, is transmitted with the enciphered data. The recipient of the data therefore receives these enciphered data accompanied by this index. On the basis of this index he reconstructs through a trusted network the encryption key 1 so as to decipher the transmitted data. Advantageously, the index 3 does not afford any information about the secret encryption key outside of the trusted network, but it makes it possible to reconstruct on demand the encryption key that it describes, if so authorized. Advantageously, the index 3 may be a shorter word than the word 1 constituting the original encryption key.

FIG. 2 presents another mode of creation of the index, using a process 20 for deduplication of the encryption key 21. In this case the storage of the blocks Ki of the encryption key are stored according to the known deduplication method, intended notably to optimize the memory space occupied by the blocks Ki. Deduplication, also called factorization or single instance storage, is a known technique for saving data, consisting in factorizing identical data sequences so as to economize on the memory space used.

As in the case of FIG. 1 the word 1, constituting the encryption key, is sliced int@ a multitude of segments or blocks 11, 12, 13, 14, 15. By way of example, the same five blocks as previously are still considered. This first slicing step 201 is followed by a second step 202 of signing the blocks using a conventional hash function. With each of the blocks Ki is associated a unique digest Sk, these digests subsequently serve to store the corresponding blocks Ki, in the memory space 2. A test 23 of the signatures Sk is performed. A new occurrence of an already identified block is not saved again but is associated with an address pointing at the same already identified block. The index 3 is created by the recovery 24 of the addresses of the digests. This address recovery operation 24 uses the result of the test 23 and the addresses pointing at the blocks in storage memory 2 to form the sequence of addresses which will make it possible to reconstruct the original encryption key 1.

In the example of FIG. 2, the first block 11 and the fourth block 14 are identical. They thus possess the same digest, or same signature, S1. The five blocks K1, K2, K3, K4, K5 are stored with the aid of the digests S1, s2, S3, S4. The index 3, forming a deduplicated key 22, then consists of the addresses at each of the blocks Ki, these addresses pointing at the identifiers. If the respective addresses of the identifiers S1, S2, S3, S4 are called @1(S1), @(S2), @(S3), @(S4), it follows that:
block K1 is associated with the address @(S1);
block K2 is associated with the address @(S2);
block K3 is associated with the address @(S3);
block K4 is associated with the address @1)(S1);
block K5 is associated with the address @(S4).

The deduplicated key 22 is thus the index 3 consisting of the sequence of addresses: (S1), @(S2), @(S3), @(S1), (S4).

In the subsequent description, the deduplicated key 22, formed by the deduplication process, will be used by way of example.

FIG. 3 presents an exemplary implementation of the method according to the invention and more particularly a possible embodiment of a system according to the invention.

To illustrate the manner of operation of a system according to the invention, a first party Alice 31 who wishes to dispatch an encrypted document to a second party Bob 32, is considered by way of example. The document to be encrypted may be any type of file in any type of format.

The invention uses a trusted network 30. The generation and the storage of the encryption key 21, 1 are performed in this trusted network, as well as the creation and the management of the deduplicated key 22.

This network comprises at least:
a deduplication server 301;
an encryption server 302, or any other encryption and decryption tool;
and an exchange server 303.

This trusted network 30 is accessible solely to the authorized parties, senders and recipients of encrypted documents. Access to the trusted network 30 is afforded by means of a strong authentication infrastructure 33 accessible solely to the authorized parties, for example by way of a portal 34. These users 31, 32 are able to authenticate themselves on this trusted network and have an application account in the exchange server 303 in order to use the services that it offers, that is to say notably encryption and decryption of documents as well as management of the encryption key and of its deduplicated key.

The deduplication server satisfies notably the following criteria:
the size of the blocks that it generates is smaller than the size of a key, so as to avoid obtaining a single block Ki;
it uses a hash function to sign the entirety of the blocks of the key.

The authentication infrastructure 33 uses for example means of biometric authentication or chip cards. In the example of FIG. 3, authentication chip cards are used.

In a prior step 101 of authentication for encryption Alice dispatches on the portal 34 a plaintext document 40 to be encrypted. Alice authenticates herself with the portal for example by means of a chip card 35. From the portal a request to obtain the encrypted document and its deduplicated key is issued to the trusted network 30.

In a first step 41, the plaintext document 40 is presented to the encryption server 302 which performs the encryption of the document 40. The encryption server creates a single-use, for example disposable, encryption key 21. The document 40 is encrypted with the aid of a private-key algorithm, using the key 21 created previously. The encryption server therefore provides the encrypted document 40′ and the encryption key 21.

The encryption key 21 is thereafter dispatched 42 to the deduplication server 301. This key 21 is stored on a benchmark using a deduplication mechanism such as described previously. The deduplication server creates for example the deduplicated key 22 in accordance with the description of FIG. 2. Upon each encryption request sent by a sender user 31, the encryption key is sliced into arbitrary blocks Ki, the blocks being different from one request to another.

More precisely the deduplication server comprises a saving server 61, a deduplication server 62 and a storage memory 63. The saving server 61 dispatches the encryption key 21, that is to say in fact the word 1 of which it consists, to the deduplication server 62. The latter delivers the segments Ki of the encryption key 21, 1 and the addresses @ i, the segments or blocks Ki being stored in the storage memory 63 at the addresses @i.

The deduplication server moreover delivers in a following step 43 the deduplicated key, formed of the sequence of addresses @ i, and the encrypted document 40′ to the exchange server 303. In a following step 44, this server 303 then delivers the encrypted document 40′ and the deduplicated key 22 to the portal 34 via the secure infrastructure 33.

Step 102 of obtaining the encrypted document and the deduplicated key from the portal 34 can then be launched by Alice 31. The latter is then in possession of this encrypted document 40′ and of the deduplicated key 22. More precisely, Alice is in possession of the encrypted document 40′ and of a secret-less private key 22. Advantageously, Alice can dispatch this encrypted document and its deduplicated key to Bob through the public network 10, the Internet for example. A spy 36 posted on this network cannot decipher the document 40′ since the deduplicated key 22 does not include any information making it possible to reconstruct the plaintext document 40. In particular, in the case of loss or theft of the deduplicated key 22 and of the encrypted document, even by knowing the encryption algorithm the attacker 36 does not have sufficient information to decipher the message.

Once he has received the encrypted document and its deduplication key Bob launches an authentication step 103 for decryption at the portal 34. He authenticates himself for example by means of a chip card 37. A request to recover the plaintext document is then issued via this portal 34 and the secure infrastructure 33 to the trusted network 30.

In a first step 51a request to decrypt the encrypted document 40′ is dispatched to the exchange server 303. The exchange server then provides 52 the deduplicated key to the deduplication server 301 which reconstructs the original encryption key 21, 1 on the basis of the addresses @ i that it contains and of the blocks Ki stored in the storage memory 63.

In a following step 53 the deduplication server 301 dispatches the encrypted document 40′ and the encryption key 21 to the encryption server 302 which decrypts the document 40′ with the aid of the key 21. Next, in a following step 54, the encryption server provides the portal 34 with the decrypted document 40. In a last step 104, Bob can then recover on portal 34 the plaintext document 40. Thus Bob, the trusted recipient, can safely connect to the system 34, 33, 30 and use the deduplicated key, secret-less, to decrypt the document 40′ without ever knowing the encryption key 21 which can advantageously be a single-use disposable key.

1. A method of securely transmitting data between at least one sender and one recipient, said method comprising:
a step of authenticating the sender to a trusted network to request the encryption of said data;
a step of encryption of said data by the trusted network with the aid of an encryption key;
a step of slicing the encryption key into arbitrary blocks;
a step of storing the blocks in a memory space;
a step of generation of an index comprising the sequence of addresses, of said blocks in the memory space;
a step of delivery, by the trusted network, of the encrypted data and of the index to the sender;
the encrypted data and the index being transmitted to the recipient via a network, the recipient being able to authenticate himself with the trusted network to provide it with the encrypted data and the index, the trusted network reconstructing the encryption key on the basis of the index decrypt the encrypted data and restoring the decrypted data to the recipient.

2. The method according to claim 1, wherein the encryption key is a single-use disposable encryption key.

3. The method according to claim 1, wherein the blocks of the encryption key are stored according to a deduplication mechanism.

4. A system for encrypting and decrypting data, said system allowing secure transmission of encrypted data between a sender user and a receiver user, and comprising at least one trusted network and one infrastructure for authentication of the users on said trusted network, the infrastructure for authentication comprising:
means for encrypting and decrypting data by means of an encryption key;
means for storing the encryption key and generating an index upon each data encryption request, said request being sent by a user, the index being created according to the following steps:
slicing of the encryption key into arbitrary blocks;
storing the blocks in a memory space;
generation of index comprising the sequence of addresses of said blocks in the memory space, the encrypted data being delivered to the sender user with the index; and
a step of delivery, by the trusted network, of the encrypted data and of the index to the sender; and
means for reconstructing the encryption key on the basis of an index upon a decryption request sent by a user, said request being accompanied by said index and encrypted data, the encryption and decryption means performing the decryption of the data by means of the reconstructed encryption key.

5. The system according to claim 4, wherein the encryption and decryption means generate before each encryption a single-use disposable encryption key, said key being used for encryption.

6. The system according to, claim 4, wherein the means for storing and for generating the index store the blocks of the encryption key according to a deduplication mechanism.

7. The system according to claim 4, wherein the means for storing, for generating the index and for reconstructing the encryption key are integrated into one and the same server.

8. The system according to claim 4, wherein the means for encrypting and decrypting data comprise an encryption server configured for:
receiving the encryption requests with the data to be encrypted;
providing the encryption keys to the index generation and storage means;
receiving the encrypted data and the reconstructed encryption key that are sent by the means for reconstructing the encryption key; and
restoring the decrypted data.

9. The system according to claim 4, wherein the trusted network comprises an exchange server configured for:
receiving the decryption requests with the encrypted data and the index;
transmitting the encrypted data and their index to the means for reconstructing the encryption key;
receiving the encrypted data and their index sent by the index generation and storage means; and
delivering the encrypted data and their index.

10. The system according to claim 4, further comprising a deduplication server, which comprises the means for storing, for generating the index and for reconstructing the encryption key.
